(19) United States
(12) Patent Application Publication
(10) Pub. No.: US 2008/0130104 A1
(43) Pub. Date: Jun. 5, 2008

(54) Fine Tuning Device

(75) Inventors: Roland Seifert, Kassel (DE); Reiner Rygiel, Altrip (DE)

Correspondence Address: HOUSTON ELISEEVA, 4 MILITIA DRIVE, SUITE 4, LEXINGTON, MA, 02421, US

(73) Assignee: Leica Microsystems Heidelberg GmbH, Manheim (DE)

(21) Appl. No.: 10/556,457

(22) PCT Filed: May 11, 2004
(86) PCT No.: PCT/EP04/05028

§ 371 Date: Nov. 17, 2006

(30) Foreign Application Priority Data
May 12, 2003 (DE) 103 21 400.3

(51) Int. Cl. G02B 21/24

(52) U.S. Cl. 359/384

(57) ABSTRACT

The invention concerns a fine tuning device for moving and/or tilting an object. The inventive fine tuning device is characterized in that a support element can rotate about an axis of rotation being guided by a guiding element. To provide tilting between the support element and the guide element, a guiding plane is defined which intersects the axis of rotation by an angle other than 90°; to provide displacement, the object is fixed on the support element with a lateral offset relative to the axis of rotation.

The invention relates to a fine tuning device for transferring and/or tipping an object.

Devices for the fine tuning of objects such as tilt mechanisms or transfer tables are used with particular frequency in optics. Positioning an object in all conceivable directions can be achieved by linear positioners with tilt mechanisms having a combination of friction bearings or ball bearings. However, stability and precision decrease with the number of individual adjustment mechanisms. In addition, a combination of several positioners and tilt mechanisms has the added disadvantage of taking up a great deal of room.

Positioning elements are often used that transfer or tip the object by bending the positioning element itself in the elastic range. Such devices, while generally less susceptible to inadvertent misadjustment, usually permit positioning only within a limited range of freedom.

In microscopy, the precise positioning of the optical components are of crucial importance for the quality of a microscope. Optimal adjustment of the optical components is particularly important in high-resolution microscopes, such as scanning microscopes and confocal scanning microscopes.

In scanning microscopy, a sample is illuminated with a light beam in order to observe the reflection or fluorescent light emitted by the sample. The focus of an illumination light beam is moved in an object plane with the help of a controllable beam deflector, generally by tipping two mirrors, whereby the axes of deflection are usually positioned perpendicular to each other, so that one mirror deflects in the x-direction and the other in the y-direction. The mirrors are tipped with the help, for example, of galvanometric positioners. The power of the light coming from the object is measured dependent on the position of the scanning beam. Generally, the positioners are provided with sensors to determine the actual position of the mirrors.

In confocal scanning microscopy in particular, an object is scanned in three dimensions with the focus of a light beam. A confocal scanning microscope generally comprises a light source, a focusing optic with which the light from the source is focused on a pinhole aperture—the so-called excitation aperture—, a beam splitter, a beam deflector to control the beam, a microscope optic, a detection aperture, and detectors to detect the detection or fluorescent light. The illumination light is coupled via a beam splitter. The fluorescent or reflection light coming from the object returns to the beam splitter via the beam deflector, passes through it, and finally focuses on the detection aperture, behind which are the detectors. Detection light that does not originate directly from the focal region takes another light path and does not pass through the detection aperture, so that pixel information is obtained that leads to a three-dimensional image as a result of sequential scanning of the object. In most cases, a three-dimensional image is achieved by layered data imaging, whereby the path of the scanning light beam ideally describes a meander on or in the object. (Scanning a line in the x-direction at a constant y-position, then interrupting x-scanning and y-repositioning to the next line to be scanned, and then scanning this line at a constant y-position in negative x-direction, etc.). To enable layered data imaging, the sample table or the objective is repositioned after scanning a layer so that the next layer to be scanned is brought into the focal plane of the objective.

Increases in resolution in the direction of the optical axis may, for example, be achieved by using a double objective arrangement (4 pi arrangement) as described in European patent application EP 0 491 289 with the title “Double confocal scanning microscope.” The light coming from the illumination system is split into two partial beams that illuminate the sample simultaneously in that they run in opposite directions to each other through two objectives that are arranged in mirror symmetry. The two objectives are arranged on different sides of their common object plane. An interference pattern, which exhibits one main maximum and several secondary maxima during constructive interference, is formed in the object point as a result of this interferometric illumination. Here, the secondary maxima are generally arranged along the optical axis. Increased axial resolution can be achieved with a double-confocal scanning microscope in comparison to a conventional scanning microscope by interferometric illumination.

Precise alignment of the objectives that are arranged in mirror symmetry in a double-confocal scanning microscope is of decisive importance for optimal functionality of the microscope. At least one of the objectives must be capable of being transferred or tipped in all three spatial directions.

The object underlying the invention is to disclose a fine tuning device that permits stable, reliable, and reproducible transferring and tipping of an object in a very small space.

The object is solved by a fine tuning device, characterized in that a carrier element is provided that can be rotated around and rotational axis guided by a guiding element, whereby
to produce tipping between the carrier element and the guiding element, a guide plane is defined that permits the rotational axis to describe an angle other than 90° and/or
to produce transferal, the object is fastened to the carrier element by means of a lateral offset to the rotational axis.

The invention has the advantage that, depending on the tilt of the guide plane or the size of the lateral offset, respectively, very precise adjustment can be achieved, because a long travel distance can be accomplished with a small adjustment without affecting functionality.

The fine tuning device according to the invention requires little space, and because of its symmetry is largely unsusceptible to inadvertent misadjustment resulting from temperature generated linear expansion.

In a preferred embodiment, the angle with which the rotational axis describes the guide plane is 1-2 degrees because this angle permits a good ratio between adjustment precision and regulating distance. However, both larger and smaller angles are easily possible.

In a particularly preferred embodiment, the guiding element is guided by a further guiding element around the rotational axis or rotationally mounted around a further rotational axis.

In a particularly preferred variant, the fine tuning device can be integrated into a further fine tuning device, whereby further fine tuning device is preferably of the type according to the invention. As a result of this nestability or stackability, the number of degrees of transfer or tipping freedom can be increased as desired, without significantly increasing the amount of room needed, whereby the reproducibility, precision of adjustment, and particularly the stability remain largely unaffected. Preferably, guide elements are provided that are exclusively dedicated to transferring, and other guide elements that are exclusively involved in tipping the object. This decoupling facilitates adjustment.

An object attached to the carrier element that is offset axis—that is, eccentric—to the rotational describes an orbit within the guide element with a radius that corresponds to the offset when the carrier element is rotated. If the carrier element is eccentrically rotatable together with the guide element within a further guide element. the carrier element and the guide element together describe a different orbit, whereby the radius of this other orbit is preferably larger than the orbit of the carrier element. By combining both adjustment options, namely that of the carrier element alone and that of the carrier element together with the guide element, the object can be transported to any arbitrary place within the circular surface area of the other orbit.

The carrier element and/or the guide element and/or the further guide element are preferably designed with a round cross-section, for example, a ring shape, which permits simple and space-saving assembly.

In a preferred embodiment, the guide element preferably exhibits a round recess, within which the preferably round guide element may be rotated. This nested arrangement can in principle be carried on arbitrarily. The recess is mounted eccentrically to transfer the object.

Preferably, a control lever can be inserted into the carrier element and/or the guide element and/or the further guide element. For this purpose, bore holes can be provided along the edge of the elements into which the control levers are to be inserted.

In a preferred embodiment, the guide element and/or the further guide element can be transferred in the direction of the rotational axis and/or the further rotational axis. The entire fine tuning device can preferably be transferred in this direction. A screw thread, for example, may be provided for this purpose. In a microscope, for example, this arrangement can be used to adjust the distance between the objective and the sample.

Preferably, elements that touch each other directly, for example, the carrier element and the guide element, are made of different materials. This has the advantage of minimizing the potential for binding or freezing. For example, one element can be made of steel and the other of brass.

In another variant, all elements are made of a glass ceramic such as Cerodur.

The object is preferably an optical component, in particular an objective or a condenser. It could, for example, also be a coupling optic for an optical fiber or it could be a different component requiring precision positioning.

Particularly advantageous is a microscope with a fine tuning device according to the invention, in particular one for precise positioning of at least one objective. The microscope can, for example, be designed as a classical light microscope, a scanning microscope, a confocal scanning microscope, a 4 pi microscope, a double-confocal scanning microscope, or a theta microscope.

The object according to the invention is schematically represented in the diagram and will be described below based on the figures, whereby elements that function the same are given the same reference numbers. They show:

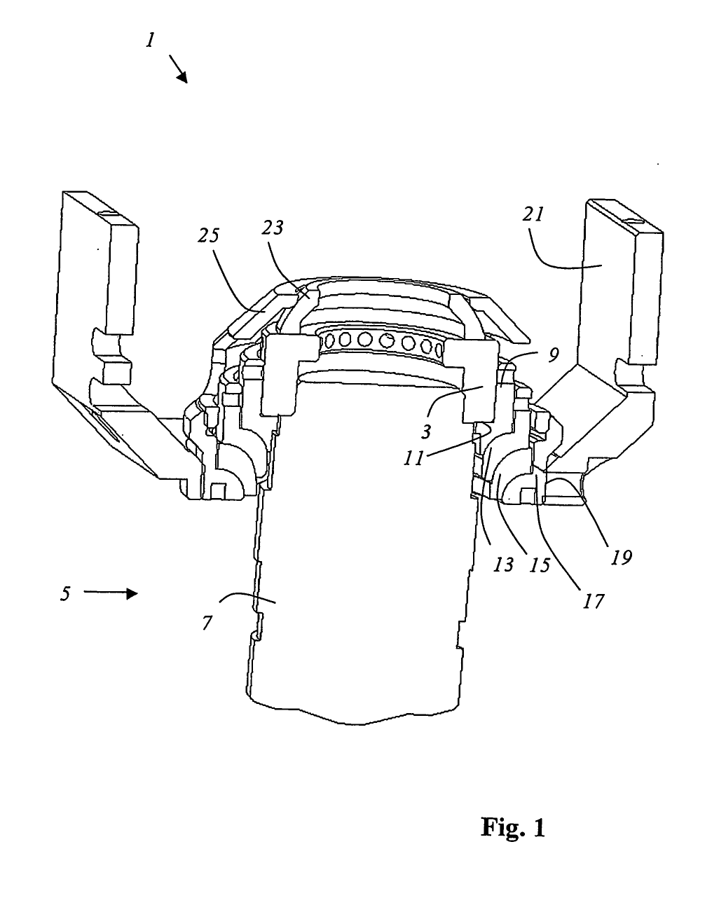

FIG. 1 a fine tuning device according to the invention in cross-section;

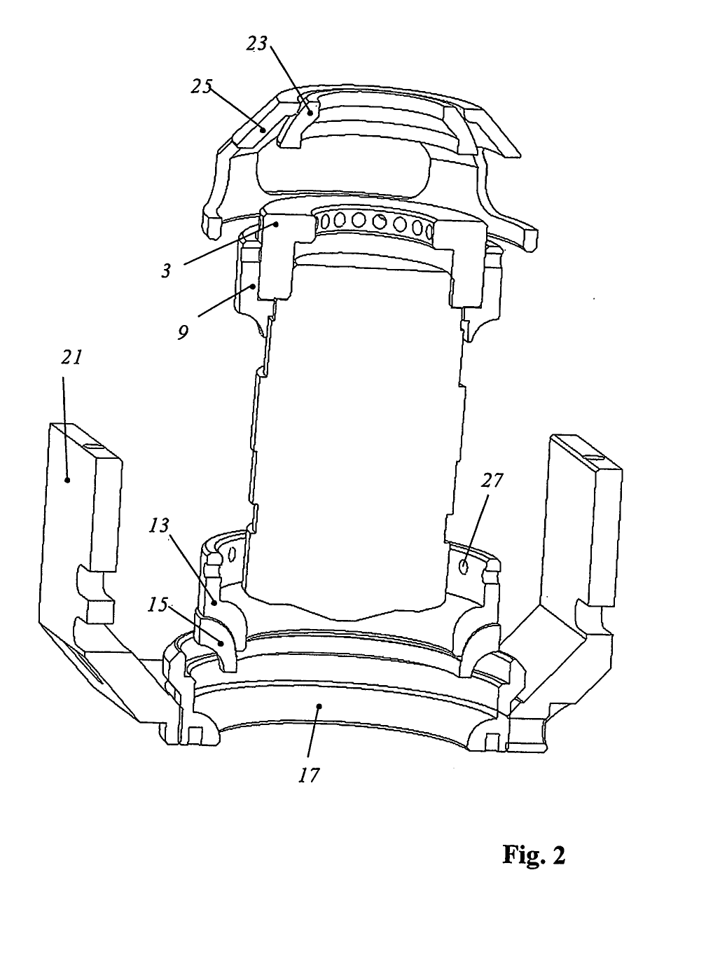

FIG. 2 the fine tuning device 1 according to the invention in an exploded view;

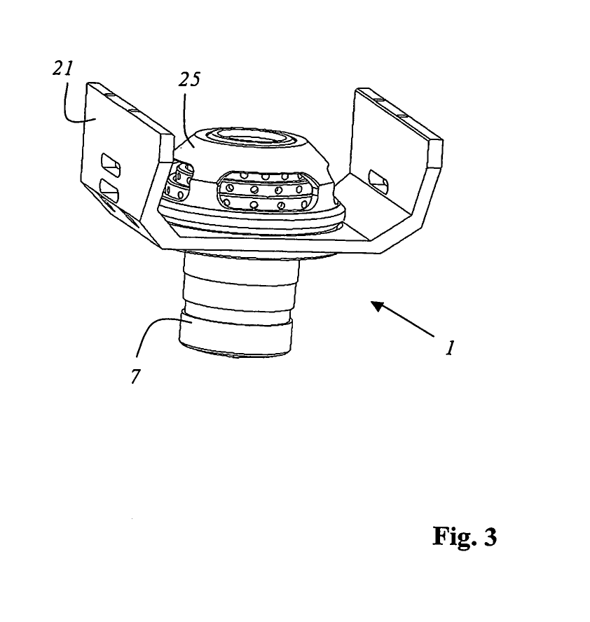

FIG. 3 the fine tuning device 1 according to the invention in projection;

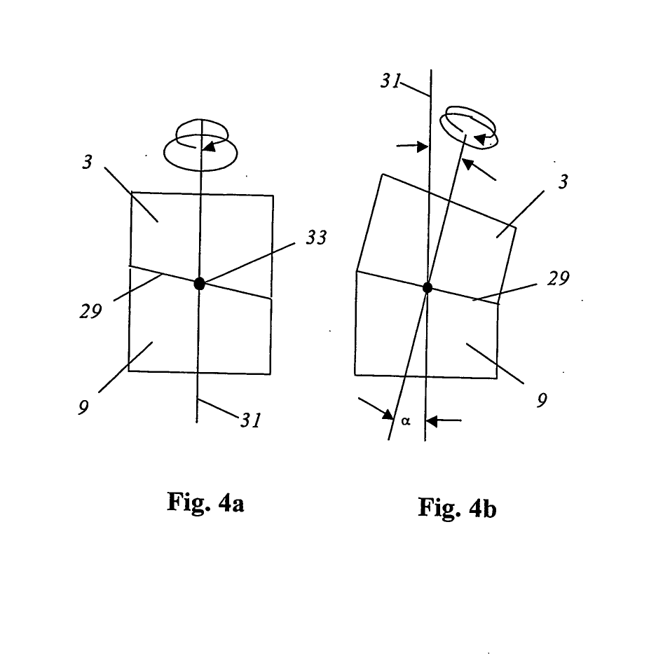

FIG. 4 the principle behind tipping of the carrier element:

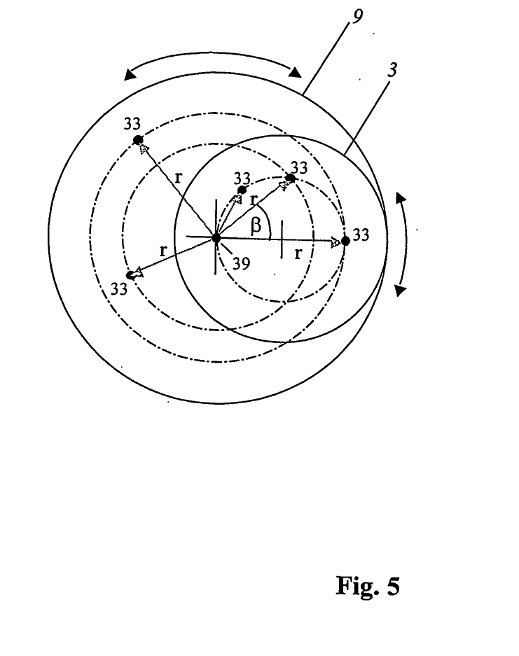

FIG. 5 the principle behind transfer and

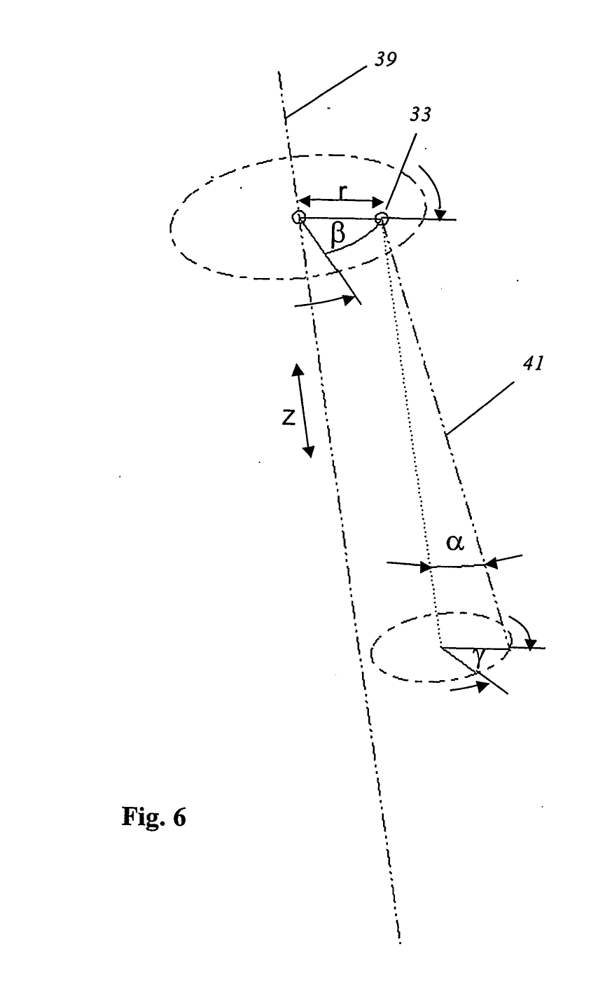

FIG. 6 the principle behind adjusting the tilt and direction of tilt of the objective.

FIG. 1 shows a fine tuning device 1 according to the invention in cross-section with a carrier element 3 that bears an object 5, in particular an objective 7, and that can be rotated around a rotational axis, guided by a guide element 9. The carrier element 3 is implemented as a diagonal cylindrical segment and is rotated in (fit into) a round recess of the guide element 9. In the longitudinal view, the guide element 9 exhibits a shoulder 11 on which the carrier element 3 sits, and which defines a guide plane that describes the rotational axis at an angle other than 90°.

The tilt of the objective 7 can be adjusted by a relative rotation between the carrier element 3 and the guide element 9, which is described in detail below in FIG. 4.

The guide element 9 can be guided into and rotated in the round recess of a further rotational axis 13. The recess of the further guide element 13 is eccentric relative to the further rotational axis (with an offset to the additional axis) so that the guide element 9 together with the carrier element 3 and the objective 7 can be tilted along an orbit determined by the eccentricity.

The further guide element 13 can be rotated around another rotational axis that is parallel to the further rotational axis when guided in the round, eccentric recess of a further guide element 15. The eccentricity of the recess of the other guide element 15 is larger than that of the further guide element 13. By combining the rotations of the further guide element 13 and the other guide element 15 in a suitable manner one can transfer precisely within a plane that is perpendicular to the other rotational axis.

The other guide element 15 is rotatably fitted in an external guide element 17. This exhibits an external screw thread 19 that enables transfer of the object—including the carrier element 3 and the guide elements 917 in the direction of the further rotational axis. The external guide element 17 is arranged with the screw thread 19 in the holding element 21. A cage 25 attached to the external guide element 17 surrounds the carrier element 3 and guide elements 9-17 and keeps the elements together with the ball-head shaped hold-down device.

The further guide element 13 and the other guide element 15, and the external guide element 17 each exhibit a rounded shoulder within the recesses by which self-centering is achieved that minimizes the danger of binding or freezing.

Forces that may be exerted by manual operation of the objective 7 are absorbed by the fine tuning device 1. The fine tuning device 1 is preferably attached to a microscope by means of two stops and can be easily replaced by another objective module without requiring renewed adjustment.

FIG. 2 shows an exploded view of the fine tuning device 1 according to the invention. The carrier element 3 and guide elements 9-17 exhibit bore holes 27 into which a control lever can be inserted.

FIG. 3 shows the assembled a fine tuning device 1 in projection.

FIG. 4 illustrates the principle of tipping of the carrier element 3 by a relative rotation between the carrier element 3 and the guide element 9. The rotational axis 31 describes the guide plane 29 at an angle other than 90°. FIG. 4a shows the base position, while FIG. 4b represents a tipped position at an angle α. The entrance pupil 33 of the objective is preferably positioned at the point of passage of the rotational axis 31 through the guide plane 29.

FIG. 5 illustrates the principle of transfer with the carrier element 3 and the guide element 9. The objective attached to the carrier element 3 that is offset to the rotational axis—that is, eccentric—describes an orbit 35 within the guide element with a radius that corresponds to the offset when the carrier element is rotated. The carrier element 3 can be rotated eccentrically together with the guide element 9, and therefore the objective 7 describes another orbit 37, 38, whereby the radius of the other orbit 37, 38 is dependent on the rotational position of the carrier element 3. The objective can be transported with a high degree of precision to any arbitrary place within the circular surface area of the other orbit 37, 38. For clarity, only the entrance pupil 33 for various adjustments is marked. The distance between the entrance pupil 33 and the base position 39 the theoretical optical axis of the microscope—is designated by r. The position of the direction of the distance vector is designated by β.

FIG. 6 shows the principle whereby tilt is adjusted—by rotating the further guide elements 13; and the direction of tilt of the objective 7 by rotating the other guide element 15. Tilt is designated by angle α, and the direction by angle γ. By rotating the external guide element 17, a z-setting becomes evident. For clarity, the objective axis 41 and the axis of the base position 39 and the optical axis of the microscope are shown.

The invention has been described in relation to a particular embodiment. It is, however, obvious that changes and modifications can be undertaken without abandoning the protective scope of the following claims.

1. Fine tuning device for transferring and/or tipping an object, wherein a carrier element is provided that can be rotated around a rotational axis guided by a guide element, whereby
tipping between the carrier element and the guide element is achieved by defining a guide plane that describes an angle other than 90° around the rotational axis and/or
transfer of the object is achieved by means of an offset that is attached to the carrier element lateral to the rotational axis.

2. Fine tuning device according to claim 1, wherein the guide element is guided by a further guide element around the rotational axis or a further rotational axis.

3. Fine tuning device according to claim 1, wherein the fine tuning device can be integrated as an element into a further fine tuning device.

4. Fine tuning device according to claim 3, wherein the further fine tuning device comprises a fine tuning device wherein a carrier element is provided that can be rotated around a rotational axis guided by a guide element, whereby tipping between the carrier element and the guide element is achieved by defining a guide plane that describes an angle other than 90° around the rotational axis and/or transfer of the object is achieved by means of an offset that is attached to the carrier element lateral to the rotational axis.

5. Fine tuning device according to claim 1, wherein the carrier element and/or the guide element and/or the further guide element are round in cross-section.

6. Fine tuning device according to claim 1, wherein the guide element exhibits a recess within which the guide element can be rotated.

7. Fine tuning device according to claim 6, wherein the recess is eccentric.

8. Fine tuning device according to claim 1, wherein the further guide element exhibits a recess within which the guide element can be rotated.

9. Fine tuning device according to claim 8, wherein the recess is eccentric.

10. Fine tuning device according to claim 1, wherein a control lever may be inserted into the carrier element and/or the guide element and/or the further guide element

11. Fine tuning device according to claim 1, wherein the guide element and/or the further guide element can be transferred in the direction of the rotational axis and/or the further rotational axis.

12. Fine tuning device according to claim 11, wherein the guide element and/or the further guide element exhibit a screw thread.

13. Fine tuning device according to claim 1, wherein elements that touch each other directly are made of different materials.

14. Fine tuning device according to claim 1, wherein the object is an optical component, in particular an objective.

15. Microscope with a fine tuning device for transferring and/or tipping an object, wherein a carrier element is provided that can be rotated around a rotational axis guided by a guide element, whereby
tipping between the carrier element and the guide element is achieved by defining a guide plane that describes an angle other than 90° around the rotational axis and/or
transfer of the object is achieved by means of an offset that is attached to the carrier element lateral to the rotational axis.

16. Microscope according to claim 15, wherein the microscope is a scanning microscope, a confocal scanning microscope, a 4 pi microscope, or a theta microscope.
